(19) United States
(12) Patent Application Publication
(10) Pub. No.: US 2004/0109029 A1
(43) Pub. Date: Jun. 10, 2004

(54) Method, system, program product and navigator for manipulating a computer display view

(75) Inventors: Karen A. Bjorkman, Arlington, MA (US); Andrew L. Schirmer, Andover, MA (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/316,701

(22) Filed: Dec. 10, 2002

(51) Int. Cl. G09G 5/00

(52) U.S. Cl. 345/772

(57) ABSTRACT

A navigator for repositioning and magnifying a computer display view is provided. Under the present invention, the navigator includes a container and an indicator. By moving the indicator around within the container, a computer display view will exhibit a corresponding change. For example, if the indicator is moved vertically, the computer display view will be magnified. If the indicator is moved horizontally, the computer display view will be repositioned horizontally.

### BACKGROUND OF THE INVENTION

1. Field of the Invention

The present invention generally relates to a method, system, program product and navigator for manipulating a computer display view. Specifically, the present invention provides a navigator that allows a computer display view to be repositioned and magnified without repeated gestures.

2. Background Art

As the use of computers becomes a part of everyday life, computer users are increasingly seeking better and more efficient ways to manipulate a computer display view. For example, when viewing data on a computer display, there is often more information than can be displayed at one time. This is true for most types of data such as text, graphics, spreadsheets, etc. The problem is compounded when applications allow “zooming” or changing of the magnification of the data so that more or less can be viewed at once. Still yet, many of today's graphical user interfaces (GUIs) allow resizing of a window in which data is displayed. Such resizing affects the amount of data viewable by the user.

Current methods for dealing with these data viewing problems typically involve the use of horizontal and/or vertical scroll bars on the GUI that the user can slide back and forth or up and down to change the computer display view horizontally or vertically, respectively. In addition, many applications provide a “magnifying glass” or the like that allows the user to change the magnification (i.e., zoom in or out). Still other interfaces provide perspective viewers that attempt to keep all data visible on the display, but at decreasing magnification and/or resolution as the data nears the edges of the display.

Unfortunately, each of these existing systems have various drawbacks. For example, not only do scroll bars consume a significant amount of space in the viewing area, but they also require separate gestures on two different units. That is, the user must make a “side to side” gesture on one scroll bar for horizontal scrolling, and an “up and down” gesture on another scroll bar for vertical scrolling. Scroll bars also fail to provide a way to change the magnification of the display view. Although “grabber hands” have been provided to allow the user to reposition the display view, they do not provide magnification and they require the user to enter a particular mode within the application. This requirement interrupts the work flow of the user, who must also exit the particular mode when repositioning is complete. “Magnifying glass” cursors have the same modal difficulties as the “grabber hands.” Specifically, they require the user to enter and exit a particular mode within the application. Moreover, “magnifying glass” cursors do not allow for horizontal and/or vertical repositioning.

Therefore, there exists a need for a method, system, program product and navigator for manipulating a computer display view. Specifically, a need exists for a single computer display view navigator (CDVN) that allows a user to reposition and magnify a computer display view without having to make repeated gestures. A further need exists for the repositioning and/or magnification of the computer display view to occur without requiring the user to enter a particular mode within the application. Still yet, a need exists for such a CDVN to be positionable about a computer display view so that it does not obstruct the workspace of the user.

### SUMMARY OF THE INVENTION

In general, the present invention provides a method, system, program product and navigator for manipulating (i.e., navigating about) a computer display view. Specifically, under the present invention, a computer display view navigator (CDVN) is provided that allows a user to both reposition (directionally) and magnify a computer display view without making repeated gestures or requiring the user to enter a particular mode within an application. The CDVN of the present invention includes a container having an indicator therein. By moving the indicator (e.g., with a mouse device or the like) within the container, the computer display view is changed accordingly. The CDVN can be positionable anywhere on the computer display view so as not to obstruct the workspace of the user.

According to a first aspect of the present invention, a computer display view navigator (CDVN) is provided. The CDVN comprises: (1) a container; and (2) an indicator within the container, wherein movement of the indicator in a first direction causes a first associated change in a computer display view, and wherein movement of the indicator in a second direction causes a second associated change in the computer display view.

According to a second aspect of the present invention, a computer display view navigator (CDVN) is provided. The CDVN comprises: (1) a first container having a first indicator, wherein movement of the first indicator in a first direction causes a first associated change in a computer display view, and wherein movement of the first indicator in a second direction causes a second associated change in the computer display view; and (2) a second container having a second indicator, wherein movement of the second indicator in the first direction causes a third associated change in the computer display view.

According to a third aspect of the present invention, a method for manipulating a computer display view is provided. The method comprises: (1) providing a computer display view navigator including a first container having a first indicator; (2) moving the first indicator in a first direction to cause a first associated change in the computer display view; and (3) moving the first indicator in the second direction to cause a second associated change in the computer display view.

According to a fourth aspect of the present invention, a system for manipulating a computer display view is provided. The system comprises: (1) a display system for displaying a computer display view navigator, wherein the computer display view navigator includes a first container having a first indicator; (2) a magnification system for causing a magnification change of the computer display view in response to a movement of the first indicator in a first direction; and (3) a directional system for causing a directional change of the computer display view in response to a movement of the first indicator in a second direction.

According to a fifth aspect of the present invention, a program product stored on a recordable medium for manipulating a computer display view is provided. When executed, the program product comprises: (1) program code for displaying a computer display view navigator, wherein the computer display view navigator includes a first container having a first indicator; (2) program code for causing a magnification change of the computer display view in response to a movement of the first indicator in a first direction; and (3) program code for causing a directional change of the computer display view in response to a movement of the first indicator in a second direction.

Therefore, the present invention provides a method, system, program product and navigator for manipulating (i.e., navigating about) a computer display view.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having a navigator system according to the present invention.

FIG. 2A depicts an exemplary navigator generated by the navigator system of FIG. 1.

FIG. 2B depicts the navigator of FIG. 2A with an elongated edge to reflect an available degree of magnification.

FIG. 2C depicts the navigator of FIG. 2A with an extended height to reflect an available degree of magnification.

FIG. 2D depicts the navigator of FIG. 2A with reduced-size indicator to reflect an available degree of magnification

FIG. 3A depicts another exemplary navigator generated by the navigator system of FIG. 1.

FIG. 3B depicts the navigator of FIG. 3A with a magnification response of a first indicator and a second indicator shown.

FIG. 3C depicts the navigator of FIG. 3A with a repositioning response of a first indicator and a second indicator shown.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, program product and navigator for manipulating (i.e., navigating about) a computer display view. Specifically, under the present invention, a computer display view navigator (CDVN) is provided that allows a user to both reposition (directionally) and magnify a computer display view without making repeated gestures or requiring the user to enter a particular mode within an application. The CDVN of the present invention includes a container having an indicator therein. By moving the indicator (e.g., with a mouse device or the like) within the container, the computer display view is changed accordingly. The CDVN can be positionable anywhere on the computer display view so as not to obstruct the workspace of the user.

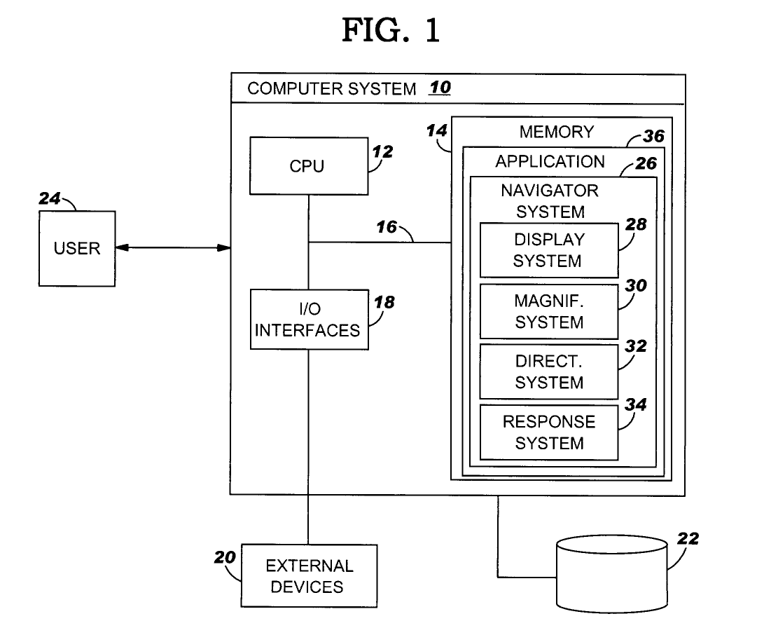

Referring now to FIG. 1, computer system 10 having navigator system 26 is shown. As shown, computer system 10 generally comprises central processing unit (CPU) 12, memory 14, bus 16, input/output (I/O) interfaces 18, external devices/resources 20 and database 22. CPU 12 may comprise a single processing unit, or be distributed across one or more processing units in one or more locations, e.g., on a client and server. Memory 14 may comprise any known type of data storage and/or transmission media, including magnetic media, optical media, random access memory (RAM), read-only memory (ROM), a data cache, a data object, etc. Moreover, similar to CPU 12, memory 14 may reside at a single physical location, comprising one or more types of data storage, or be distributed across a plurality of physical systems in various forms.

I/O interfaces 18 may comprise any system for exchanging information to/from an external source. External devices/resources 20 may comprise any known type of external device, including speakers, a CRT, LED screen, hand-held device, keyboard, mouse, voice recognition system, speech output system, printer, monitor, facsimile, pager, etc. Bus 16 provides a communication link between each of the components in computer system 10 and likewise may comprise any known type of transmission link, including electrical, optical, wireless, etc. In addition, although not shown, additional components, such as cache memory, communication systems, system software, etc., may be incorporated into computer system 10.

Database 22 is optional and could provide storage for information such as, for example, user 24 preferences, data etc. As such, database 22 may include one or more storage devices, such as a magnetic disk drive or an optical disk drive. In another embodiment, database 22 includes data distributed across, for example, a local area network (LAN), wide area network (WAN) or a storage area network (SAN) (not shown). Database 22 may also be configured in such a way that one of ordinary skill in the art may interpret it to include one or more storage devices.

Stored in memory 14 of computer system 10 is navigator system 26 and application 36 (shown as a program products). As depicted, navigator system 26 includes display system 28, magnification system 30, directional system 32 and response system 34. In general, navigator system 26 can be part of any program or application 36 that can be operated by user 24. Examples of application 36 include a word processing program, a spreadsheet program, a graphics program, a personal digital assistant platform, etc. As will be described in detail below, navigator system 26 will generate and display a navigator that can be operated by user 24 to manipulate a computer display view. Specifically, the navigator generated under the present invention allows both repositioning and magnification of a computer display view. To this extent, the navigator of the present invention can replace the scroll bars, navigator hands and magnifying glasses used in previous applications.

It should be understood that computer system 10 is intended to represent any type of computerized system that can be operated or accessed by user 24 and that can execute applications or other programs. For example, computer system 10 could be a personal computer, a workstation, a personal digital assistant, a cellular telephone, etc. In addition, it should be understood that user 24 can be access computer system 10 directly, or from another computerized “user” system (not shown) that includes computerized components similar to computer system 10. In such an event, communication between the user system and the computer system 10 can occur via a direct hardwired connection (e.g., serial port), or via an addressable connection in a client-server (or server-server) environment which may utilize any combination of wireline and/or wireless transmission methods. In the case of the latter, the server and client may be connected via the Internet, a wide area network (WAN), a local area network (LAN), a virtual private network (VPN) or other private network. The server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

Under the present invention, application 36 will generate and display a particular “view” for user 36. For example, if application 36 is a word processing program, user 24 will be presented with a particular interface through which he/she can create a document. In previous applications, user 24 manipulated the display view (e.g., scrolled horizontally or vertically) through the use of scroll bars or the like. Under the present invention, display system 28 will generate and display a multi-functioned navigator in lieu of (or in addition to) such previous navigation systems.

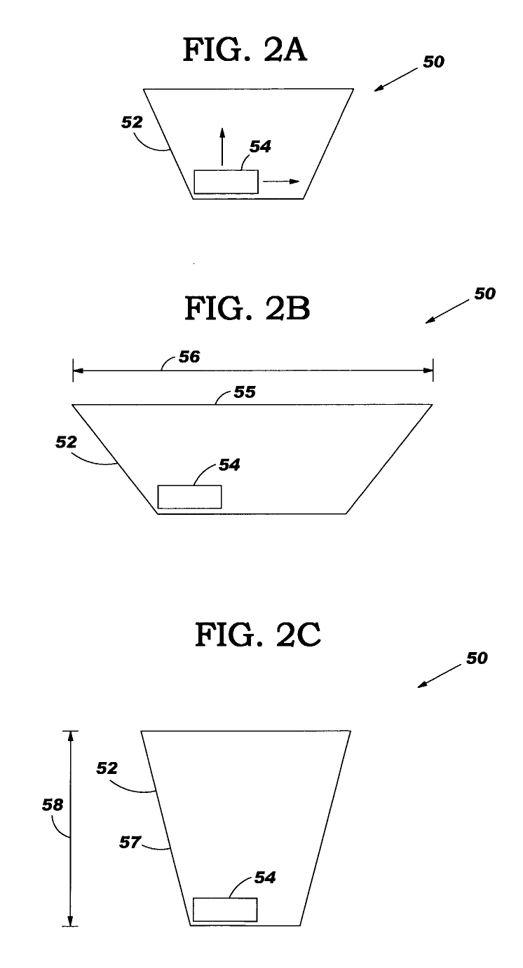

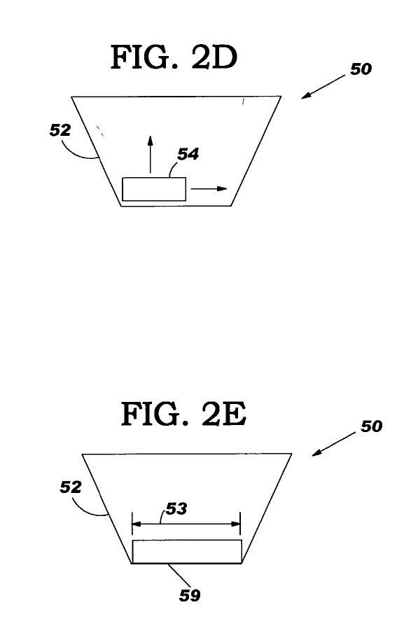

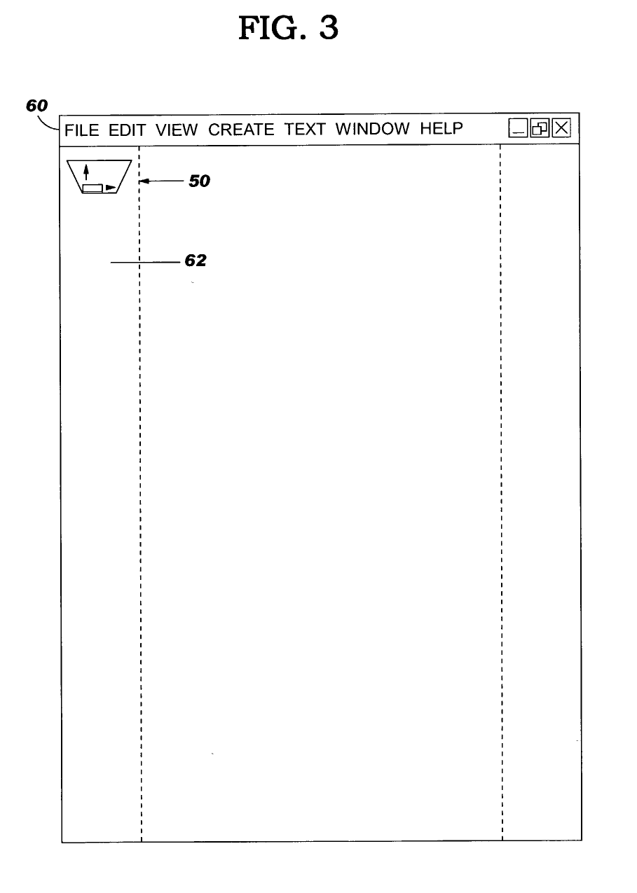

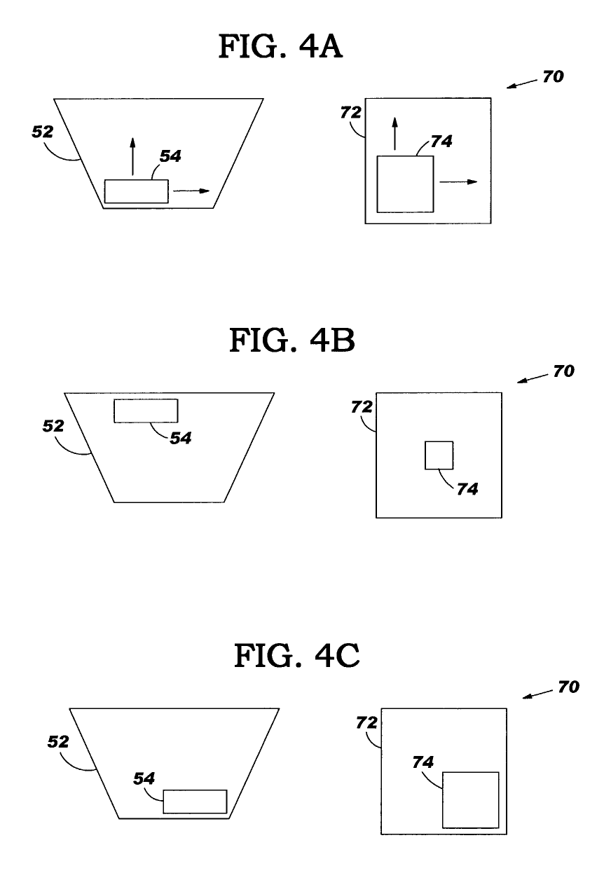

Referring to FIG. 2A, navigator 50 (CDVN) generated by display system 28 according to the present invention is shown. As depicted, navigator 50 includes container 52 and indicator 54. It should be understood that container 52 is trapezoidal in shape according to one illustrative embodiment of the present invention, and that the teachings discussed herein could be used in conjunction with containers of various shapes (e.g., rectangular, circular, etc.) In any event, navigator 50 is freely positionable about a computer display view (e.g., by user 24) so as to be minimally obstructive. For example, if navigator 50 is initially displayed along a top edge of the computer display view, user 24 could reposition navigator 50 manually (e.g., with a mouse device or the like). FIG. 3 shows navigator 50 positioned on computer display view 60. As shown, navigator has been positioned within margin 62 of a document. Referring back to FIG. 2A, user 24 can manipulate computer display view 60 by moving indicator 54 around within container 52. Specifically, if user 24 wishes to magnify computer display view 60, user 24 will move indicator 54 vertically (up and down) within container 52. Upon so moving indicator 54, magnification system 30 of navigator system 26 will change computer display view 60 to reflect an associated degree of magnification. For example, if indicator 54 is moved to the top of container 52, computer display view 60 will be magnified to a maximum amount. Alternatively, if user 24 moves indicator 54 horizontally (laterally) within container 52, directional system 32 will reposition computer display view 60 horizontally to reflect as much. For example, if indicator 54 is moved completely to the right of container 52, computer display view 60 will be repositioned completely to the right.

As can be seen, navigator 50 provides user 24 with an effective way to both reposition and magnify computer display view 60. In the event user 24 wishes to vertically reposition computer display view 60, user 24 could move indicator 54 in conjunction with a manipulation of a “toggle key.” For example, user 24 could move indicator 54 vertically (or horizontally) while pressing a certain key on a key board. Alternatively, user 24 could move indicator 54 with a different mouse button than used when attempting to magnify computer display view 60. In any event, when user 24 manipulates the applicable toggle key and moves indicator 54, directional system 32 will cause a vertical repositioning of computer display view 60 in an amount corresponding to the movement of indicator 54.

Unlike previous systems, indicator 50 of the present invention can also be changed based on a type of data displayed to reflect an available degree of magnification. Specifically, it is well known that different types of data can require different degrees of magnification. For example, a page of text will require a much different degree of magnification than will a page of 1000 pictures. To accommodate this difference, and to provide user 24 with efficient magnification controls, display system 28 will display navigator 50 according to the degree of magnification available. To this extent, many variations are possible. In a first embodiment, container 52 itself is changed to reflect the degree of magnification. For example, as shown in FIG. 2B, top edge 55 of container 52 can be elongated or extended as shown by dimension arrows 56. Lengthening top edge 55 increases the maximum available magnification for computer display view 60. Alternatively, as shown by dimension arrows 58 in FIG. 2C, height 57 of container 52 can be increased to reflect a different degree of magnification. In this case, lengthening container 52 height 57 gives finer-grained control over zooming. In another embodiment, as shown in FIG. 2D, indicator 54 itself can be changed. For example, to reflect a higher degree of magnification, indicator 54 can be made smaller. In this embodiment, the size of indicator 54 shows the relative size of the current display view within the scope of minimum and maximum available magnification. Thus, as shown by dimension arrows 53 in FIG. 2E, when indicator 54 is positioned along bottom edge 59 of container 52 (i.e., computer display view 60 is zoomed out), indicator 54 is as wide as bottom edge 59 is long. This positioning of indicator 54 typically allows all data to be in view.

It should be understood that the various alternatives for reflecting an available degree of magnification are not limited to those discussed herein. For example, a combination of changing an edge length or a height of container 52 could be implemented. Moreover, container 52 could have a different shape (e.g., rectangular) than trapezoidal.

Referring now to FIG. 4A, another navigator 70 according to the present invention is shown. Similar to navigator 50, navigator 70 is generated and displayed by display system 28. As depicted, navigator 70 includes container 52 having indicator 54 as well as container 72 having indicator 74. In this embodiment, the height of 74 represents the height of computer display view 60 relative to the height of the data, at the current magnification. Similarly, the width of indicator 74 represents the width of computer display view 60 relative to the width of the data, at the current magnification.

Navigator 70 is positionable about computer display view 60 in a similar manner to navigator 50 and allows vertical repositioning of computer display view 60 without requiring manipulation of a toggle key. Similar to navigator 50, if user 24 wishes to magnify computer display view 60, user 24 will move indicator 54 vertically within container 52. Alternatively, under this embodiment, user 24 could perform some non-movement-based toggling of indicator 74. For example, user 24 could double-click indicator 74 to achieve the desired magnification. In any event, magnification system 30 will cause an associated change in magnification of computer display view 60. If user 24 wishes to reposition computer display view 60 horizontally, user 24 can move either indicator 54 or indicator 74 horizontally. Such movement of either indicator 54 or 74 will result in directional system 32 causing an associated horizontal change in computer display view 60. In the event user 24 wishes to reposition computer display view 60 vertically, user 24 can simply move indicator 74 vertically, or user 24 can move indicator 54 and manipulate a toggle key (similar to navigator 50).

In any event, whenever indicator 54 or 74 is moved, response system 34 of navigator system 26 will cause an automatic, associated response by the other indicator. For example, referring to FIG. 4B, if indicator 54 is moved vertically (e.g., to zoom in), indicator 74 will be automatically decreased in size by a proportionate amount. Referring to FIG. 4C, if indicator 54 is moved horizontally (e.g., to the left), indicator 74 will also move horizontally. To this extent, the opposite is also true. That is, if indicator 74 is moved or otherwise manipulated, indicator 54 will have an associated movement/response. Thus, for example, if indicator 74 is double-clicked to zoom in on computer display view 60, indicator 54 could be automatically moved upward within container 52 by response system 34 (FIG. 1) in a proportionate amount.

It should be understood that although not shown, navigator 70 could also be changed based on data displayed to reflect an available degree of magnification (similar to navigator 50). For example, similar to FIGS. 2A-D, containers 52 and 72 and/or indicators 54 and 74 could be altered by display system 28. It should also be understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, controls computer system 10 such that it carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which— when loaded in a computer system— is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

We claim:

1. A computer display view navigator, comprising:
a container; and
an indicator within the container, wherein movement of the indicator in a first direction causes a first associated change in a computer display view, and wherein movement of the indicator in a second direction causes a second associated change in the computer display view.

2. The computer display view navigator of claim 1, wherein the movement of the indicator in the first direction causes an associated magnification change of the computer display view.

3. The computer display view navigator of claim 2, wherein the first direction is vertical.

4. The computer display view navigator of claim 1, wherein the movement of the indicator in the second direction causes an associated horizontal repositioning of the computer display view.

5. The computer display view navigator of claim 4, wherein the second direction is horizontal.

6. The computer display view navigator of claim 1, wherein the movement of the indicator in conjunction with manipulation of a toggle key causes a third associated change of the computer display view.

7. The computer display view navigator of claim 6, wherein the movement of the indicator in conjunction with the manipulation of the toggle key causes an associated vertical repositioning of the computer display view.

8. The computer display view navigator of claim 1, wherein a dimension of the container changes based on a type of data displayed to reflect an available degree of magnification.

9. The computer display view navigator of claim 8, wherein the change in dimension of the container comprises a change in a length of an edge of the container.

10. The computer display view navigator of claim 8, wherein the change in dimension of the container comprises a change in height of the container.

11. The computer display view navigator of claim 1, wherein a dimension of the indicator changes based on a type of data displayed to reflect an available degree of magnification.

12. A computer display view navigator, comprising:
a first container having a first indicator, wherein movement of the first indicator in a first direction causes a first associated change in a computer display view, and wherein movement of the first indicator in a second direction causes a second associated change in the computer display view; and
a second container having a second indicator, wherein movement of the second indicator in the first direction causes a third associated change in the computer display view.

13. The computer display view navigator of claim 12, wherein the movement of the first indicator causes an associated response by the second indicator, and wherein the movement of the second indicator causes an associated response by the first indicator.

14. The computer display view navigator of claim 12, wherein the movement of the first indicator in the first direction causes an associated magnification change of the computer display view.

15. The computer display view navigator of claim 14, wherein the first direction is vertical.

16. The computer display view navigator of claim 12, wherein the movement of the first indicator in the second direction causes an associated horizontal repositioning of the computer display view.

17. The computer display view navigator of claim 16, wherein the second direction is horizontal.

18. The computer display view navigator of claim 12, wherein the movement of the second indicator in the first direction causes an associated vertical repositioning of the computer display view.

19. The computer display view navigator of claim 12, wherein a dimension of the first container changes based on a type of data displayed to reflect an available degree of magnification.

20. The computer display view navigator of claim 19, wherein the change in dimension of the first container comprises a change in a length of an edge of the first container.

21. The computer display view navigator of claim 19, wherein the change in dimension of the first container comprises a change in height of the first container.

22. The computer display view navigator of claim 12, wherein a dimension of the first indicator changes based on a type of data displayed to reflect an available degree of magnification.

23. A method for manipulating a computer display view, comprising:
providing a computer display view navigator including a first container having a first indicator;
moving the first indicator in a first direction to cause a first associated change in the computer display view; and
moving the first indicator in the second direction to cause a second associated change in the computer display view.

24. The method of claim 23, wherein moving the first indicator in the first direction causes an associated magnification change of the computer display view, and wherein moving of the first indicator in the second direction causes an associated horizontal repositioning the computer display view

25. The method of claim 23, further comprising:
providing a second container having a second indicator in the computer display view navigator; and
moving the second indicator to cause a third associated change in the computer display view.

26. The method of claim 25, wherein the step of moving the second indicator comprises moving the second indicator in the first direction to cause the third associated change in the computer display view.

27. The method of claim 25, wherein the third associated change is a vertical repositioning of the computer display view.

28. The method of claim 25, wherein moving the first indicator causes an associated response by the second indicator, and wherein moving the second indicator causes an associated response by the first indicator.

29. A system for manipulating a computer display view, comprising:
a display system for displaying a computer display view navigator, wherein the computer display view navigator includes a first container having a first indicator;
a magnification system for causing a magnification change of the computer display view in response to a movement of the first indicator in a first direction; and
a directional system for causing a directional change of the computer display view in response to a movement of the first indicator in a second direction.

30. The system of claim 29, wherein the dimensional change is in response to the movement of the first indicator in a vertical direction.

31. The system of claim 29, wherein the directional change of the computer display view is a horizontal repositioning, and wherein the horizontal repositioning is caused in response to the movement of the first indicator in a horizontal direction.

32. The system of claim 29, wherein a dimension of the first container is changed based on a type of data displayed to reflect an available degree of magnification.

33. The system of claim 29, wherein a dimension of the first indicator is changed based on a type of data displayed to reflect an available degree of magnification

34. The system of claim 29, wherein the computer display view navigator further comprises a second container having a second indicator, and wherein movement of the second indicator in the first direction causes a vertical repositioning in the computer display view.

35. The system of claim 34, further comprising a response system, wherein movement of the first indicator causes an associated response by the second indicator, and wherein movement of the second indicator causes an associated response by the first indicator.

36. A program product stored on a recordable medium for manipulating a computer display view, which when executed, comprises:
program code for displaying a computer display view navigator, wherein the computer display view navigator includes a first container having a first indicator;
program code for causing a magnification change of the computer display view in response to a movement of the first indicator in a first direction; and
program code for causing a directional change of the computer display view in response to a movement of the first indicator in a second direction.

37. The program product of claim 36, wherein the dimensional change is in response to the movement of the first indicator in a vertical direction.

38. The program product of claim 36, wherein the directional change is a horizontal repositioning, and wherein the horizontal repositioning is in response to the movement of the first indicator in a horizontal direction.

39. The program product of claim 36, wherein a dimension of the first container is changed based on a type of data displayed to reflect an available degree of magnification.

40. The program product of claim 36, wherein a dimension of the first indicator is changed based on a type of data displayed to reflect an available degree of magnification

41. The program product of claim 36, wherein the computer display view is changed in a vertical direction in response to a movement of the first indicator in conjunction with manipulation of a toggle key.

42. The program product of claim 36, wherein the computer display view navigator further comprises a second container having a second indicator, and wherein movement of the second indicator in the first direction causes a vertical repositioning in the computer display view.

43. The program product of claim 42, wherein movement of the first indicator causes an associated response by the second indicator, and wherein movement of the second indicator causes an associated response by the first indicator.
